(19) United States
(12) Patent Application Publication
(10) Pub. No.: US 2026/0082006 A1
(43) Pub. Date: Mar. 19, 2026

(54) UNIT, APPARATUS, CONTROL METHOD FOR THE UNIT, AND STORAGE MEDIUM

(71) Applicant: CANON KABUSHIKI KAISHA, Tokyo (JP)

(72) Inventor: TAKERU IMAMURA, Chiba (JP)

(21) Appl. No.: 19/325,036

(22) Filed: Sep. 10, 2025

(30) Foreign Application Priority Data
Sep. 18, 2024 (JP) 2024-160830

(51) Int. Cl. H04N 1/00; G03G 15/00

(52) U.S. Cl. CPC H04N 1/00896; G03G 15/5004; H04N 1/00689

(57) ABSTRACT

An image forming apparatus includes a detection unit configured to detect a return factor in the image forming apparatus, and a control unit configured to perform power-on control on the image forming apparatus in any case where the detection unit detects the return factor or where a signal indicating return is received from another image forming apparatus.

### BACKGROUND

### Field of the Technology

The present disclosure relates to a unit, an apparatus, a control method for the unit, and a storage medium.

### Description of the Related Art

An information processing apparatus, such as an image forming apparatus, performs power control according to a use situation of a user for the purpose of power saving. As an example of the power control, with a power saving mode prepared in which the information processing apparatus operates with a small amount of power when the information processing apparatus is not used for a certain period of time, the information processing apparatus returns to a normal power mode in response to an input from a user. Examples of the user input includes input by a user on an operation unit, such as a touch panel or a numeric keypad, and input through remote operation via a network, and thus, a user input function necessary according to the apparatus is prepared. Examples of the user input function of image forming apparatuses include, in addition to an operation via an operation unit and a network, facsimile (FAX) reception, document detection, and opening/closing detection.

Japanese Patent Laid-Open No. 2019-160241 describes a technique providing a high-speed return from the power saving mode according to the control of switching devices to which power is supplied based on the state of the power saving mode. The technique described in Japanese Patent Laid-Open No. 2019-160241 implements a high-speed return from the power saving mode by performing return control in parallel, instead of performing activation control in order at the time of return from the power saving mode.

The technique described in Japanese Patent Laid-Open No. 2019-160241shortens the time to perform the return control between the devices, but the timing of power supply from a user input to each device is the same, not allowing the return time of each device itself to be shortened.

### SUMMARY

The present disclosure is directed to allowing early power-on control in response to detection of a return factor.

According to an aspect of the present disclosure, an image forming apparatus includes a detection unit configured to detect a return factor in the image forming apparatus, and a control unit configured to perform power-on control on the image forming apparatus in any case where the detection unit detects the return factor or where a signal indicating return is received from another image forming apparatus.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating an example of a configuration of an image forming system.

FIG. 2 is a diagram illustrating an example of a hardware configuration of an image forming apparatus.

FIG. 3 is a block diagram illustrating details of hardware of the image forming apparatus.

FIG. 4 is a power supply system diagram of the image forming apparatus.

FIG. 5 is a block diagram illustrating details of power supply control signals in an operation unit.

FIG. 6 is a flowchart illustrating return control from a power saving mode.

FIG. 7 is a flowchart illustrating return control from the power saving mode.

FIGS. 8A and 8B are diagrams illustrating a communication flow of return control from the power saving mode.

FIG. 9 is a block diagram illustrating details of power supply control signals in a scanner.

FIG. 10 is a flowchart illustrating return control from the power saving mode.

FIGS. 11A and 11B are diagrams illustrating a communication flow of return control from the power saving mode.

### DESCRIPTION OF THE EMBODIMENTS

Hereinafter, embodiments will be described with reference to the drawings. However, the constituents described in the following embodiments are merely examples, and the present disclosure is not limited thereto.

### First Embodiment

### System Configuration

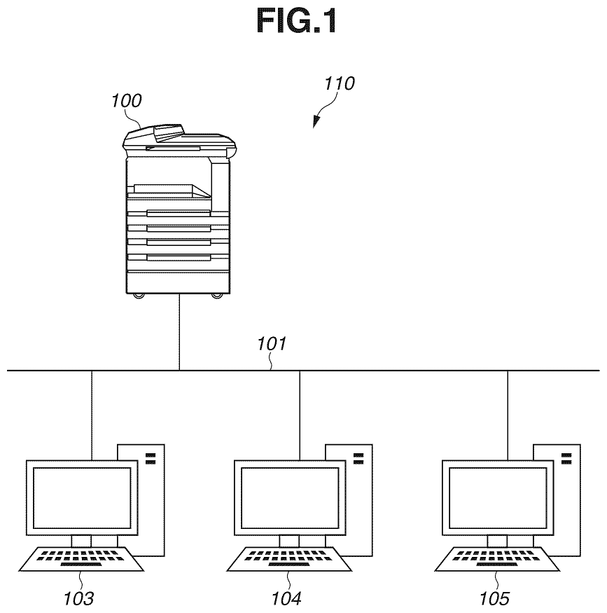

FIG. 1 is a diagram illustrating an example of a configuration of an image forming system 110 according to a first embodiment. The image forming system 110 includes an image forming apparatus 100, a local area network (LAN) 101, and a plurality of personal computers (PCs) 103, 104, and 105.

The image forming apparatus 100 is an example of an information processing apparatus. An example in which the information processing apparatus is an image forming apparatus that performs image formation will be described. The image forming apparatus 100 can be applied to any information processing apparatus including a control unit that generates image data for screen display and an operation unit that displays a screen on a display unit included in the operation unit based on the image data generated by the control unit to receive a user operation. For example, the image forming apparatus 100 can also be applied to an information processing apparatus, such as a printing apparatus, a reading apparatus, a copying machine, or a FAX apparatus.

In an image forming system 110 illustrated in FIG. 1, the image forming apparatus 100 is connected to the plurality of PCs 103, 104, and 105 via the LAN 101.

The PC 103 generates a print job including data described in a print language, such as a Page Description Language (PDL), or data in a specific data format (compressed in Joint Bi-level image Experts Group (JBIG) or another format) based on a user operation. The PC 103 transmits the generated print job to the image forming apparatus 100 via the LAN 101. In response to the image forming apparatus 100 receiving the print job from an external device, such as the PC 103, the image forming apparatus 100 executes image formation (printing) based on the received print job.

The PC 103 can remotely access the image forming apparatus 100 via the LAN 101. The PC 103 is configured to operate the image forming apparatus 100 and monitor the state of the image forming apparatus 100 via remote access. The image forming apparatus 100 is configured to notify an external device, such as the PC 103, of the state of the image forming apparatus 100.

### Configuration of Image Forming Apparatus 100

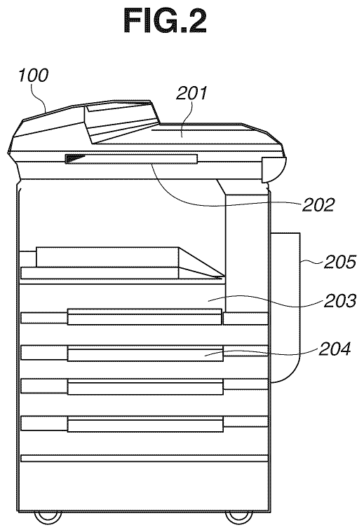

FIG. 2 is a diagram illustrating an example of a hardware configuration of the image forming apparatus 100. The image forming apparatus 100 includes a scanner 201, an operation unit 202, sheet feeding cassettes 204, a toner replacement opening/closing unit 203, and a manual sheet feeding cassette 205.

The scanner 201 is a unit that reads a document set by a user, and captures image data by reading a sheet manually placed on a platen or continuously reading a document placed on an Auto Document Feeder (ADF).

The operation unit 202 is a unit that receives user operations, and includes a liquid crystal display (LCD) panel that displays screens and a touch panel that receives input coordinates from a user.

The image forming apparatus 100 includes also the sheet feeding cassettes 204 and 205 in which paper to be printed is set, and executes printing on the paper set by a user. The image forming apparatus 100 includes consumable parts, and for example, the image forming apparatus 100 includes the toner replacement opening/closing unit 203 that is opened and closed to replace toner or ink used for printing.

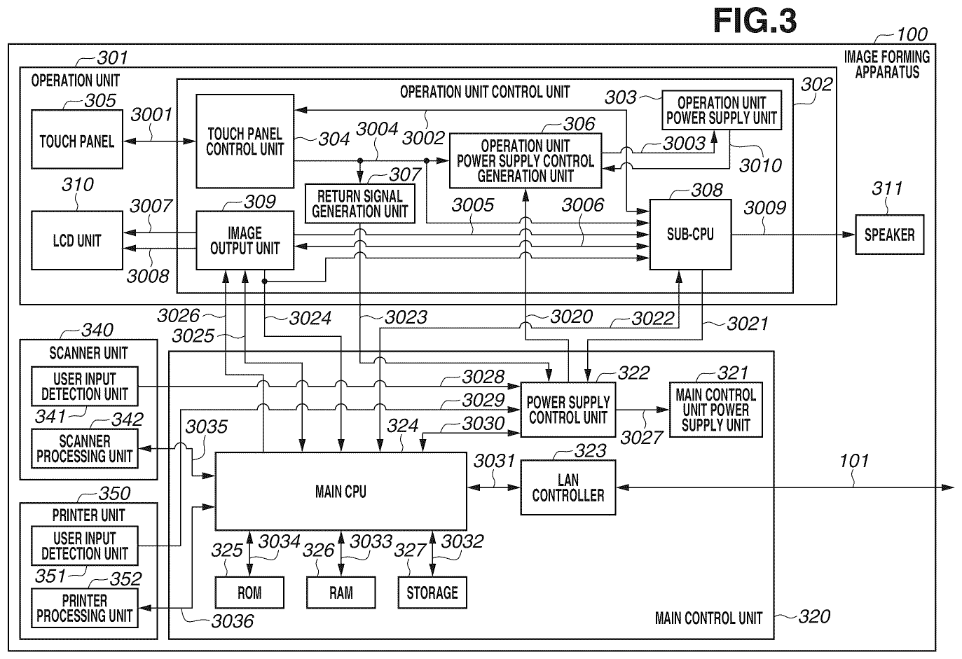

FIG. 3 is a block diagram illustrating details of the image forming apparatus 100. The image forming apparatus 100 includes an operation unit 301, a main control unit 320, a scanner unit 340, and a printer unit 350.

The operation unit 301 includes an operation unit control unit 302, a touch panel 305, an LCD unit 310, and a speaker 311. The operation unit control unit 302 includes an operation unit power supply unit 303, a touch panel control unit 304, an operation unit power supply control generation unit 306, a return signal generation unit 307, a sub-central processing unit (CPU) 308, and an image output unit 309.

The main control unit 320 includes a main control unit power supply unit 321, a power supply control unit 322, a LAN controller 323, a main CPU 324, a read only memory (ROM) 325, a random-access memory (RAM) 326, and a storage 327.

The scanner unit 340 includes a user input detection unit 341 and a scanner processing unit 342. The printer unit 350 includes a user input detection unit 351 and a printer processing unit 352. The main CPU 324 is connected to blocks via signals 3030, 3031, and 3032 to 3026 to communicate with each other.

The main control unit 320 of the image forming apparatus 100 includes the main CPU 324 that generally controls the image forming apparatus 100.

The operation unit 301 functions as a user interface (UI), and includes the sub-CPU 308, an input device (the touch panel 305) that receives user operations, and a display device (the LCD unit 310) that displays screens.

In the present embodiment, a form in which the main control unit 320 generates image data for screen display of the LCD unit 310 to output the image data to the operation unit 301 will be described as an example.

The operation unit 301 includes the LCD unit 310 (the display unit), which displays a screen based on image data generated by the main control unit 320 and receives user operations. The configuration of generation of image data for screen display is not limited to the configuration in which the image data is generated by the main control unit 320 as in the present embodiment, and may be a configuration in which the image data is generated by the sub-CPU 308 or another unit in the operation unit 301.

The printer unit 350 performs an image forming process on a sheet-form recording medium (paper sheet) according to, for example, an electrophotographic method. The printer unit 350 may employ not only an electrophotographic system, but also another recording method, such as an inkjet method or a thermal transfer method.

The main control unit 320 includes the main CPU 324, the ROM 325, the RAM 326, the storage 327, the LAN controller 323, the power supply control unit 322, and the main control unit power supply unit 321. The main control unit 320 implements a print function by controlling the printer processing unit 352 in the printer unit 350 to print an image, for example, in accordance with a print job received from an external device. In addition, the main control unit 320 implements a copy function by controlling the scanner unit 340 and the printer unit 350 to print an image based on image data obtained by reading a document image by the scanner processing unit 342 in the scanner unit 340.

The main CPU 324 generally controls the image forming apparatus 100. The main CPU 324 reads and executes programs stored in the ROM 325 or the storage 327, implementing functions of the image forming apparatus 100, such as a print function and a copy function.

The RAM 326 is a volatile memory, such as a double data rate synchronous dynamic random access memory (DDR SDRAM). The RAM 326 is used to store programs executed by the main CPU 324 and temporary data used by the main CPU 324.

The storage 327 is a storage device, such as a solid state drive (SSD) connected to the main CPU 324 via, for example, Serial Advanced Technology Attachment (SATA). The storage 327 is used to temporarily store various types of setting information relating to the image forming apparatus 100 and image data used in the print function or the copy function.

The LAN controller 323 is connected to the main CPU 324 and the LAN 101. The LAN controller 323 controls communication with an external device, such as the PC 103, performed via the LAN 101.

The image forming apparatus 100 has a function of detecting user inputs. For example, the scanner unit 340 includes, as the user input detection unit 341, an original detection sensor on the ADF and an opening/closing detection sensor that detects an opening/closing operation for detecting a sheet on the platen. The printer unit 350 also includes, as the user input detection unit 351, an opening/closing detection sensor for the toner replacement opening/closing unit 203, opening/closing detection sensors for the sheet feeding cassettes 204, and a document detection sensor for the manual sheet feeding cassette 205.

The image forming apparatus 100 has a plurality of power modes, such as a job execution mode for executing jobs, such as printing, and a standby mode capable of receiving jobs, or a power saving mode for supplying minimum power and detecting user inputs, and another type of mode. The power supply state in the job execution mode and the power supply state in the standby mode may be the same, or may be switched so that the unit to which power is supplied is changed based on a user operation. For example, when a job involved with the scanner unit 340 is input, the power supply control is performed to supply power to the scanner unit 340.

The power supply control unit 322 generally controls power supply to the entire image forming apparatus 100. The power supply control unit 322 performs control to turn on/off the power supply provided in the main control unit 320 in the image forming apparatus 100 when power is not supplied to the main CPU 324, or the printer unit 350 or the scanner unit 340. When power is supplied to the main CPU 324, and the printer unit 350 and scanner unit 340, the main CPU 324 controls the power supply control unit 322 to turn on/off the power supply to each unit. The power supply control by the power supply control unit 322 may be implemented by a CPU of the power supply control unit 322 executing programs or by using hardware logic, such as a programmable logic device (PLD).

The power supply control unit 322 performs control to turn on/off the power supply in the image forming apparatus 100 using a return signal 3023 from the operation unit 301, a return signal (not illustrated) from the LAN controller 323, or the like as a trigger. Through the control, the power supply control unit 322 causes the image forming apparatus 100 to shift from the power saving mode to the standby mode. Further, the power supply control unit 322 controls the power supply to the operation unit 301.

The operation unit 301 is connected to the main control unit 320 via an image data signal 3026, an image communication signal 3025, and a sub-CPU communication signal 3022. The operation unit 301 is further connected to the main control unit 320 via a ready signal 3021, a ready signal 3024, the return signal 3023, and a power mode notification signal 3020.

The ready signal 3021 indicates that the sub-CPU 308 is in an operable state (a state in which a communication signal 3022 is ready to be received).

The ready signal 3024 indicates that the image output unit 309 is ready to receive the image communication signal 3025 and the image data signal 3026, and is notified from the image output unit 309 to the main CPU 324 and the sub-CPU 308 in the operation unit 301.

The return signal 3023 causes the image forming apparatus 100 to return from the power saving mode, and is transmitted from the return signal generation unit 307 to the power supply control unit 322.

The power mode notification signal 3020 notifies the operation unit power supply control generation unit 306 of the operation unit 301 whether the image forming apparatus 100 is in the power saving mode or the standby mode.

The image output unit 309 of the operation unit 301 receives an instruction or information from the main control unit 320 via the image data signal 3026, the image communication signal 3025, and the sub-CPU communication signal 3022 to perform display control of the LCD unit 310.

The operation unit 301 notifies the sub-CPU 308 of user operations received via the touch panel 305, and notifies the main control unit 320 of user operations via the sub-CPU communication signal 3022.

On the other hand, the main CPU 324 monitors the ready signal 3021 to determine whether the sub-CPU 308 is in the operable state (a state in which the sub-CPU communication signal 3022 is ready to be received). The main CPU 324 further monitors the ready signal 3024 to determine whether the image output unit 309 is ready to receive the image communication signal 3025 and the image data signal 3026.

The operation unit 301 includes the sub-CPU 308, the touch panel 305, the LCD unit 310, and the speaker 311. The operation unit control unit 302 includes the sub-CPU 308, the touch panel control unit 304, the image output unit 309, the operation unit power supply unit 303, the operation unit power supply control generation unit 306, and the return signal generation unit 307.

The touch panel control unit 304 is connected to the sub-CPU 308, the touch panel 305, and the return signal generation unit 307. The touch panel control unit 304 is connected to the touch panel 305 via a control signal 3001, and detects a touch input to the touch panel 305 by monitoring the control signal 3001.

In addition, the touch panel control unit 304 notifies the sub-CPU 308 and the return signal generation unit 307 that a touch input from a user to the touch panel 305 has been performed, using a touch detection signal 3004.

The touch panel control unit 304 communicates with the sub-CPU 308 via a control signal 3002.

The sub-CPU 308 is also referred to as an operation unit CPU, and transmits setting information for appropriately detecting a touch input, for example, relating to correction of a touch sensitivity or a touch coordinate deviation with respect to the touch panel 305, to the touch panel control unit 304 via the control signal 3002.

The sub-CPU 308 also receives information indicating that a touch input to the touch panel 305 has been performed, via the touch detection signal 3004 from the touch panel control unit 304. Further, when the sub-CPU 308 receives information indicating that a touch input to the touch panel 305 has been performed, from the touch panel control unit 304, the sub-CPU 308 reads, via the control signal 3002 from the touch panel control unit 304, input operation data (touched coordinates and pressing pressure) corresponding to an input operation of a user received on the touch panel 305.

The sub-CPU 308 transmits input operation data received from the touch panel control unit 304 via the sub-CPU communication signal 3022 to the main CPU 324.

The image output unit 309 is connected to the LCD unit 310 to control image display on the LCD unit 310. That is, the image output unit 309 functions as an example of an image output circuit that generates an image signal for screen display based on image data received from the main control unit 320 to output the image signal to the LCD unit 310. The image output unit 309 controls the LCD unit 310 using an image output signal 3007 and a backlight control signal 3008. The backlight control signal 3008 is used for control to turn on/off the backlight of the LCD unit 310 (lighting control) and setting of brightness and the like.

The image output unit 309 is also connected to the main CPU 324 and the sub-CPU 308.

The image output unit 309 exchanges a control signal 3006 with the sub-CPU 308. The image output unit 309 exchanges the image data signal 3026, the image communication signal 3025, and the ready signal 3024 with the main CPU 324. The ready signal 3024 is output from the image output unit 309 to the main CPU 324, and is used to notify whether the image output unit 309 is ready to receive the image communication signal 3025 and the image data signal 3026.

An image-receiving-in-progress signal 3005 is output from the image output unit 309, and is used to notify whether an image to be displayed on the LCD unit 310 is being received from the main CPU 324 via the image data signal 3026 to the image output unit 309. The image-receiving-in-progress signal 3005 is connected to the sub-CPU 308 to allow the sub-CPU 308 to monitor the image reception status signal 3005.

The ready signal 3024 output from the image output unit 309 is connected to the sub-CPU 308 as well as the main CPU 324 to allow the sub-CPU 308 to monitor the ready signal 3024. This enables the sub-CPU 308 to monitor the image-receiving-in-progress signal 3005 and the ready signal 3024 indicating that the image output unit 309 is ready to receive image data.

The main CPU 324 transmits image data about a screen to be displayed on the LCD unit 310 to the image output unit 309 mounted on the operation unit 301 as the image data signal 3026. The main CPU 324 transmits setting information for setting screen display, such as setting of the size or the orientation of a screen displayed on the LCD unit 310, to the image output unit 309 using the image communication signal 3025.

The image output unit 309 generates an image signal that can be received by the LCD unit 310 based on image data received as the image data signal 3026 from the main CPU 324 and the setting information received as the image communication signal 3025. The image output unit 309 transmits the generated image signal to the LCD unit 310 as the image output signal 3007. The image output unit 309 generates, for example, a low-voltage differential signaling (LVDS) signal or a red, green, and blue (RGB) analog or digital signal as an image signal that can be received by the LCD unit 310.

The LCD unit 310 displays a screen in accordance with the image output signal 3007 received from the image output unit 309. Further, when the image output unit 309 becomes ready to output an image to the LCD unit 310 after receiving image data and setting information from the main CPU 324, the image output unit 309 notifies the sub-CPU 308 of the status using the image-receiving-in-progress signal 3005.

The sub-CPU 308 performs control to turn on/off the backlight of the LCD unit 310 (lighting control) and setting of brightness and the like on the image output unit 309 via the control signal 3006. The sub-CPU 308 controls the speaker 311 using the control signal 3009. For example, the sub-CPU 308 causes the speaker 311 to output a confirmation beep indicating that an input from a user has been received, and audio indicating an operation instruction to the user or information, such as the state of the image forming apparatus 100. The speaker 311 may be controlled by the main CPU 324 instead of the sub-CPU 308.

The return signal generation unit 307 receives information indicating a change in user input to the touch panel 305 via the touch detection signal 3004 from the touch panel control unit 304. The return signal generation unit 307 returns the image forming apparatus 100 from the power saving mode to the standby mode via notification to the power supply control unit 322 using the received touch detection signal 3004. In this case, the touch detection signal 3004 is an interrupt signal whose logic level (H/L) changes based on a user input, and the return signal 3023 is a signal that is generated from a circuit that detects the change in the logic level and latches the change until the return from the power saving mode, but the details thereof will be omitted in the present embodiment. In addition, with a plurality of power saving modes, for example, if power is supplied to the sub-CPU 308, a circuit that outputs a return signal from the sub-CPU 308 may be employed.

The operation unit power supply control generation unit 306 has two input signals: One is a reception return signal from the inside of a unit in the operation unit 301, such as the touch detection signal 3004 for receiving information indicating a change in user input to the touch panel 305 from the touch panel control unit 304. The other is the power mode notification signal 3020 received from a unit other than the operation unit 301. Specifically, the unit other than the operation unit 301 is the main control unit 320 that outputs the power mode notification signal 3020.

The operation unit power supply control generation unit 306 has the touch detection signal 3004 as a return signal in the unit and the power mode notification signal 3020 received from the other unit, allowing both return via the power mode notification signal 3020 in the unit through an operation on the operation unit 301 and return from the main control unit 320 via detection, such as a document detection by the user input detection unit 341 in the scanner unit 340. Return from the power saving mode via the two return signals makes it possible to return without waiting for an instruction from the main control unit 320 when a user input is performed on the operation unit 301, allowing early return from the power saving mode. On the other hand, an operation on another unit, such as the scanner unit 340, can also cause return from the main control unit 320. As described above, the two return signal reception circuitry makes it possible to perform return control from the power saving mode based on a user operation.

The operation unit 301 also uses the touch detection signal 3004 output from the touch panel control unit 304 as information indicating a change in user input to the touch panel 305 for return control from the power saving mode. Specifically, the return signal 3023 to be transmitted to another unit via the return signal generation unit 307 is transmitted as a return signal to the operation unit power supply control generation unit 306 that performs in-unit power supply control. In this manner, transmitting the return signal 3023 to be transmitted to another unit to the operation unit power supply control generation unit 306, which performs in-unit power supply control, to, in response to detection of a user input, perform power supply return control of the operation unit 301 and power supply return control of the image forming apparatus 100 in parallel allows early return of the operation unit 301 from the power saving mode at the time of return via the operation unit 301.

The configuration in which units having return signals, such as the operation unit 301, transmit and receive a plurality of return signals provides early return of the unit from the power saving mode in return control and also makes it possible to perform both return control of another unit and return control from another unit.

In the return from the power saving mode using such a return signal, the return from the power saving mode is performed using the power supply control signal 3003 output from the operation unit power supply control generation unit 306, and the operation unit power supply unit 303 supplies power to the entire operation unit 301.

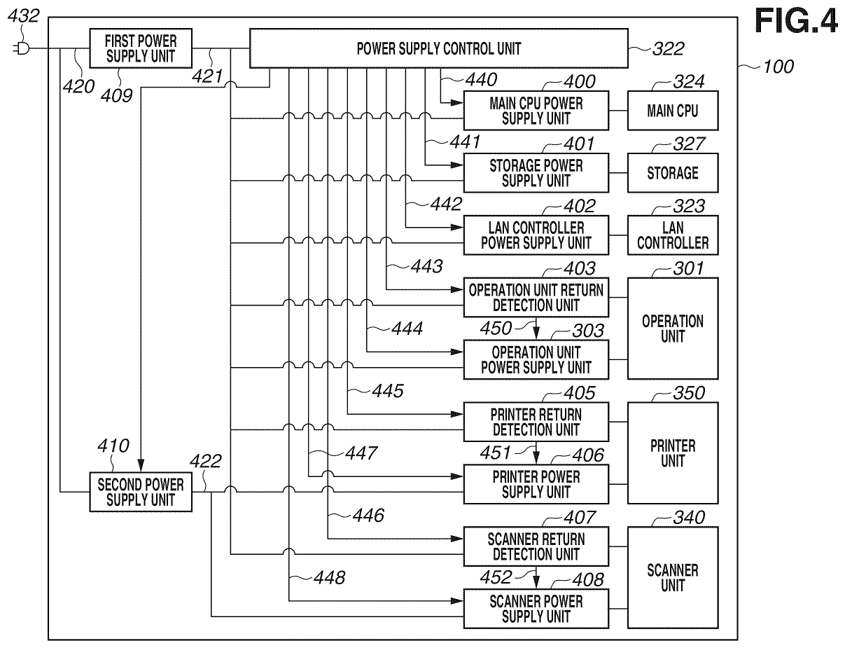

FIG. 4 is a diagram illustrating an example of a power supply system of the image forming apparatus 100. The image forming apparatus 100 includes the main CPU 324, the storage 327, the LAN controller 323, the operation unit 301, the printer unit 350, and the scanner unit 340. The image forming apparatus 100 further includes a main CPU power supply unit 400, a storage power supply unit 401, a LAN controller power supply unit 402, an operation unit return detection unit 403, the operation unit power supply unit 303, a printer return detection unit 405, and a printer power supply unit 406. The image forming apparatus 100 further includes a scanner return detection unit 407, a scanner power supply unit 408, a first power supply unit 409, and a second power supply unit 410.

The image forming apparatus 100 is connected to an outlet via a power cord 432. The power supply input through the power cord 432 is supplied to the first power supply unit 409 and the second power supply unit 410 included in the image forming apparatus 100 via a power line 420. The first power supply unit 409 supplies power in response to the power cord 432 being connected to an outlet, whereas the second power supply unit 410 starts power supply via an instruction from the power supply control unit 322 when a user instruction to turn on the power is received using a rocker switch (SW), a push-button SW, or the like.

The power supply control unit 322 also performs control to stop the supply of power to the second power supply unit 410 in the power saving mode. The power supply control unit 322 is supplied with power from the first power supply unit 409 via a power supply line 421. The power supply to the power supply control unit 322 may be performed in response to connection to an outlet or only when the power supply is turned on using a rocker SW.

The power supply control unit 322 supplies power based on the power mode of the image forming apparatus 100. In the case of only outlet connection in a power-off mode, power is not supplied to the components other than the power supply control unit 322. In the standby mode or the job execution mode, both of which printing or scanning can be executed in, control to supply power to all units is performed. In a standby state in which the image forming apparatus 100 receives only a user instruction, the supply of power to the scanner unit 340 and the printer unit 350 may be turned off.

The image forming apparatus 100 has the power saving mode other than the power-off mode and the standby mode, and the power saving mode is a power mode in which only power that can be restored from a user input is supplied. Thus, power is supplied to each block based on the power mode. For example, the power supply control unit 322 controls power supply control of the main CPU power supply unit 400 via a power supply control signal 440 for controlling the power supply to the main CPU 324 based on the power mode.

The image forming apparatus 100 is configured to switch a block to which power is supplied, via a plurality of control signals 442 to 446.

Switching between units to which power is supplied within each block may be controlled. Specific description will be given in the following. There is an integrated circuit (IC) which receives a plurality of power supplies and has a power saving setting. This type of IC is a component that achieves power saving by turning off a subset of the power supplies under the control of the power supply control unit 322 with the IC in a power saving mode.

Similarly to the power supply to the main CPU 324, the power supply control unit 322 performs power supply control using a power supply control signal for controlling power supply based on the power mode of each block so as to perform power supply control of the storage power supply unit 401 using the power supply control signal 441 for controlling power supply to the storage 327 based on the power mode. A block having a plurality of power modes includes a unit that has a function of receiving user inputs. The unit having a function of receiving user inputs includes a power supply for return operation and a power supply for normal operation separately. The power supply for return operation and the power supply for normal operation have different power supply control signals from each other.

Specifically, the operation unit 301 is connected to the operation unit return detection unit 403 and the operation unit power supply unit 303. The operation unit return detection unit 403 has a return control signal 450 (hereinafter, referred to as a return signal 450) to be sent to the operation unit power supply unit 303. Similarly, the printer unit 350 and the scanner unit 340 also include the return detection units 405 and 407, respectively. The return detection units 405 and 407 have return signals 451 and 452, respectively. The printer unit 350 may have the printer power supply unit 406 or may have the printer power supply unit 406 as one of common power supply units. The scanner unit 340 may have the scanner power supply unit 408 or may have the scanner power supply unit 408 as one of common power supply units.

The operation unit 301 may be supplied with power via the main control unit 320 or directly from the first power supply unit 409. The operation unit 301 generates, in the operation unit 301, a signal for returning the operation unit 301 from the power saving mode. The operation unit 301 in the power saving mode returns from the power saving mode via the return signal generated by the operation unit 301. Since the operation unit 301 returns from the power saving mode via the return signal generated by the operation unit 301, the return signal does not need to pass through the main control unit 320, allowing early return.

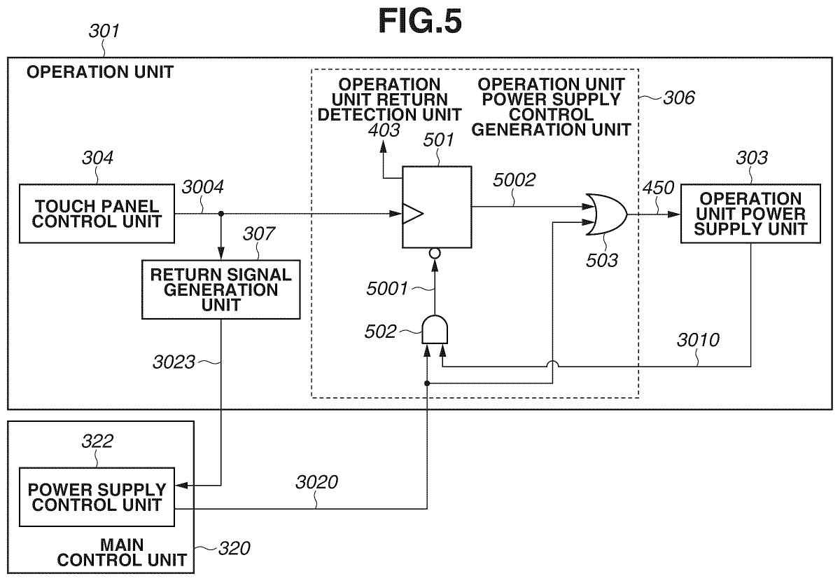

FIG. 5 is a block diagram illustrating details of power supply control signals of the operation unit 301. The operation unit 301 includes the operation unit power supply unit 303, the touch panel control unit 304, the operation unit power supply control generation unit 306, and the return signal generation unit 307. The operation unit power supply control generation unit 306 includes a latch circuit 501, a logic 502, and a logic 503. The main control unit 320 includes the power supply control unit 322.

The operation unit 301 performs return control from the power saving mode using the touch detection signal 3004 output when the touch panel control unit 304 determines that an input has been performed from a user. The touch detection signal 3004 is output to the return signal generation unit 307 and the operation unit power supply control generation unit 306. The return signal generation unit 307 is connected to the power supply control unit 322 via the return signal 3023 that is output to the main control unit 320 and via which the entire image forming apparatus 100 is returned from the power saving mode. On receiving the return signal 3023, the power supply control unit 322 starts a return operation from the power saving mode.

The return signal generation unit 307 performs control to output the return signal 3023 only in the power saving mode so as not to cause erroneous detection in the standby mode, and control to output the return signal 3023 with a certain width or more so as to reliably receive the touch detection signal 3004, but details thereof will be omitted in the present embodiment.

The operation unit power supply control generation unit 306 performs power supply control of the operation unit 301. The touch detection signal 3004 is connected to the latch circuit 501. The latch circuit 501 performs control using, for example, a flip-flop circuit. The latch circuit 501 as one example includes a clear pin, and is configured to issue an off command when the operation unit power supply unit 303 is in an ON state and the power supply control unit 322 is in the standby mode.

Specifically, the operation unit power supply control generation unit 306 includes the logic 502 configured to clear the latch circuit 501 in a case where both a power state notification signal 3010 indicating that the operation unit power supply unit 303 is turned ON and the power mode notification signal 3020 from the power supply control unit 322 indicate the standby mode. A clear signal 5001 output from the logic 502 is connected to the clear pin of the latch circuit 501, and the latch circuit 501 sets a latch return signal 5002 to L (a low level) when the clear signal 5001 causes the latch circuit 501 to enter a clear state.

The latch circuit 501 also controls the latch return signal 5002 such that the operation unit 301 returns from the power saving mode when the logic is changed via a user input detection by the touch detection signal 3004. Specifically, the latch circuit 501 uses power supply of the operation unit return detection unit 403, which is supplied with power even in the power saving mode, as an input signal, and sets the input to be H (a high level) at all times, so that the latch return signal 5002 is set to be H in response to the touch detection signal 3004.

The power supply control unit 322 outputs the power mode notification signal 3020 for controlling the power supply of the operation unit 301, and the operation unit power supply unit 303 is subjected to power supply control based on the power mode notification signal 3020. The return signal 450 output from the operation unit power supply control generation unit 306 is output by the logic 503 that outputs H indicating ON in a case where either the latch return signal 5002 or the power mode notification signal 3020 that is output indicates that the operation unit power supply unit 303 is to be turned ON.

As described above, a unit of the operation unit 301 having the function of receiving user inputs transmits the return signal 3023 in response to a user input to the power supply control unit 322 as a unit of the main control unit 320, and also generates the return signal 450 in the unit and transmits the return signal 450, allowing early return from the power saving mode in return control of the unit.

It is desirable for the operation unit power supply control generation unit 306 to be used in return control from the power saving mode, and for the transition operation to be performed only from the power supply control unit 322. The reason is that use of the operation unit power supply control generation unit 306 at the time of transition from the power saving mode could prevent a communication partner, specifically the operation unit 301, from communicating without an instruction from the main control unit 320, causing the main control unit 320 to detect that state as an anomaly to determine the state to be an error. Thus, the signal from the operation unit power supply control generation unit 306 may be only used in return from the power saving mode.

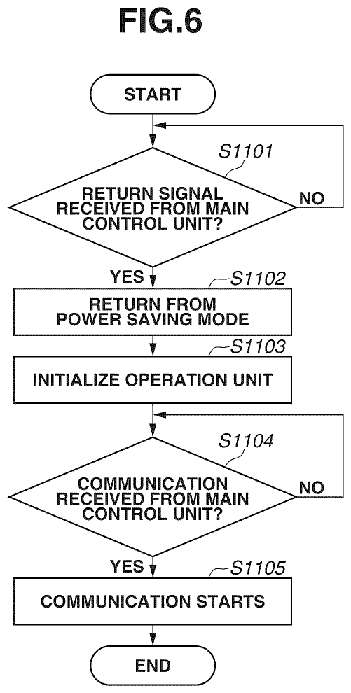

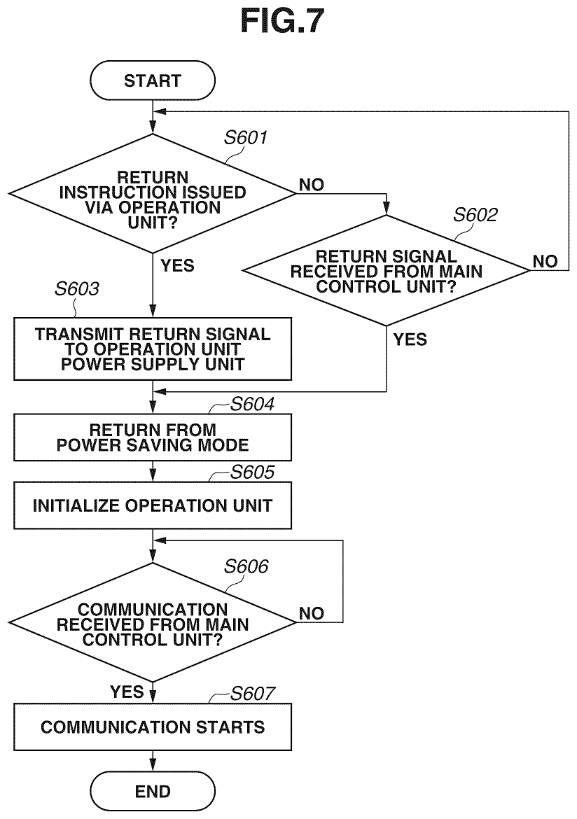

FIG. 6 is a control flowchart of a comparative example in which the operation unit 301 subjected to user input performs power supply control only using the power supply control unit 322 included in the main control unit 320. FIG. 7 is a control flowchart in which the operation unit 301 subjected to user input performs return control in the unit in response to a user input according to the present exemplary embodiment.

First, details of the control flowchart of FIG. 6 will be described. The operation unit 301 in the power saving mode (power-off control) starts the process of the flowchart in FIG. 6.

In step S1101, the operation unit 301 in the power saving mode receives the power mode notification signal 3020 from the main control unit 320. Then, the operation unit 301 determines whether the power mode notification signal 3020 indicates return from the power saving mode to another mode (the standby mode or the job execution mode). The power mode notification signal 3020 is an example of a return signal. If the operation unit 301 determines that the power mode notification signal 3020 does not indicate return from the power saving mode (NO in step S1101), the processing returns to step S1101, and the power saving mode is maintained until return. If the operation unit 301 determines that the power mode notification signal 3020 indicates return from the power saving mode (YES in step S1101), the processing proceeds to step S1102.

In step S1102, the operation unit power supply unit 303 performs an operation for returning from the power saving mode to another mode (the standby mode or the job execution mode). Specifically, the operation unit power supply unit 303 functions as a control unit that performs power-on control on the operation unit 301 as the return operation. In the power saving mode before the return, the operation unit power supply unit 303 performs power-off control on the operation unit 301. In step S1102, after the operation unit power supply unit 303 returns from the power saving mode, the processing proceeds to step S1103.

In step S1103, the operation unit control unit 302 performs an operation for initializing the operation unit 301.

In step S1104, the operation unit control unit 302 determines whether the operation unit control unit 302 has received communication including communication start from the main control unit 320. Specifically, the operation unit 301 checks the state of a state signal indicating that the main control unit 320 is ready to communicate and the state of a state signal indicating that the operation unit 301 is ready to communicate, and determines whether the operation unit 301 has received initial communication. If a communication state can be established only via the initial communication, a state signal indicating a communicable state may be omitted. If the operation unit control unit 302 determines that the operation unit control unit 302 has received no communication (NO in step S1104), the processing returns to step S1104. If the operation unit control unit 302 determines that the operation unit control unit 302 has received communication (YES in step S1104), the processing proceeds to step S1105.

In step S1105, the operation unit control unit 302 starts communication with the main control unit 320.

The flowchart according to the present embodiment of FIG. 7 will now be described. The description of FIG. 7 will be focused on differences from the flowchart of FIG. 6. The operation unit 301 is an operation unit. The main control unit 320 is a main control unit. The operation unit 301 in the power saving mode (power off control) starts the process of the flowchart of FIG. 7.

Hereinafter, a method of controlling the operation unit 301 will be described.

In step S601, the operation unit power supply control generation unit 306 receives the touch detection signal 3004 from the touch panel control unit 304 with the operation unit 301 being in the power saving mode. Then, the operation unit power supply control generation unit 306 determines whether the touch detection signal 3004 indicates that a user input via touch has been performed. If the touch detection signal 3004 indicates that a user input has been performed (YES in step S601), the operation unit power supply control generation unit 306 determines that the indication is regarded as an issuance of a return instruction, and the processing proceeds to step S603. If the touch detection signal 3004 does not indicate that a user input has been performed (NO in step S601), the operation unit power supply control generation unit 306 determines that the touch detection signal 3004 indicates no issuance of a return instruction, and the processing proceeds to step S602.

A user input via touch is an example of the return factor. It is sufficient that the touch panel control unit 304 functions as a detection unit that detects a return factor on the operation unit 301 and then outputs the touch detection signal 3004. The return factor is, for example, an operation of a user on the operation unit 301. If a return factor on the operation unit 301 is detected (YES in step S601), the operation unit power supply control generation unit 306 determines that the detection is regarded as an issuance of a return instruction, and the processing proceeds to step S603. If no return factor is detected on the operation unit 301 (NO in step S601), the operation unit power supply control generation unit 306 determines that no detection is regarded as no issuance of a return instruction, and the processing proceeds to step S602.

The operation of step S602 is similar to that of step S1101 in FIG. 6. If the operation unit power supply control generation unit 306 determines that the power mode notification signal 3020 does not indicate return from the power saving mode (NO in step S602), the processing returns to step S601, and the power saving mode is maintained until return. If the operation unit power supply control generation unit 306 determines that the power mode notification signal 3020 indicates return from the power saving mode (YES in step S602), the operation unit power supply control generation unit 306 transmits the return signal 450 to the operation unit power supply unit 303, and the processing proceeds to step S604.

In step S603, the operation unit power supply control generation unit 306 transmits the return signal 450 to the operation unit power supply unit 303, and the processing proceeds to step S604. In this manner, the two determinations made in steps S601 and S602 allows return from the power saving mode based on a return instruction from either the operation unit 301 or the main control unit 320. The return signal generation unit 307 transmits the return signal 3023 to the power supply control unit 322 of the main control unit 320. The return signal 3023 indicates return.

The operations of steps S604 to S607 are similar to those of steps S1102 to S1105 in FIG. 6, and thus description thereof will be omitted.

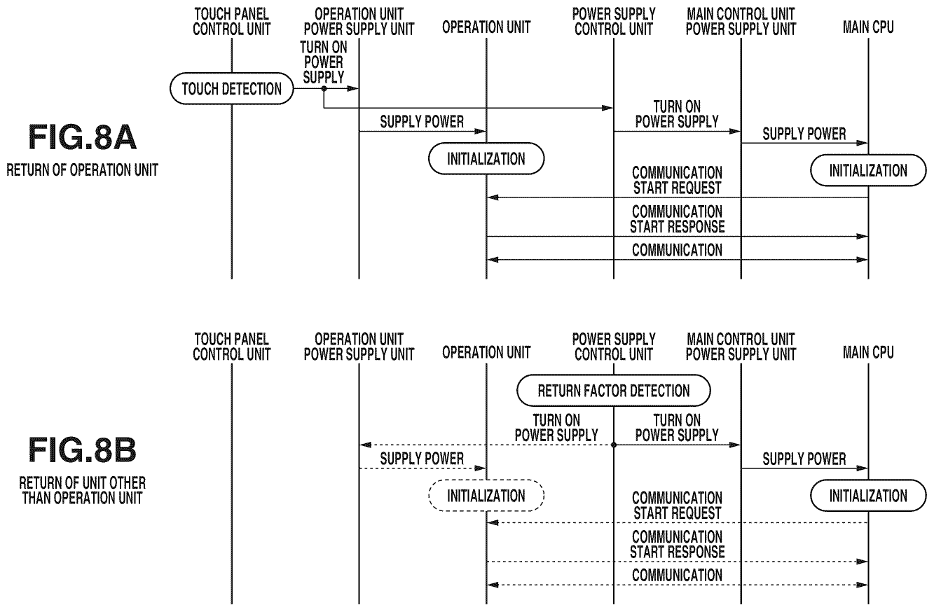

FIGS. 8A and 8B each illustrate a communication flow of each block in a return operation from the power saving mode. FIG. 8A illustrates the return control from the operation unit 301, and FIG. 8B illustrates the return control from the main control unit 320, which is return control from a unit other than the operation unit 301.

The flow of FIG. 8A will be described in detail first. When the touch panel control unit 304 detects a touch as a user input, the touch panel control unit 304 transmits a power-on instruction to the operation unit power supply unit 303 and the power supply control unit 322. On receiving the power-on instruction, the operation unit power supply unit 303 supplies power to the entire operation unit 301 through power-on control. On receiving the power-on instruction, the power supply control unit 322 instructs the entire image forming apparatus 100 to return from the power saving mode. In FIGS. 8A and 8B, only the main control unit 320 is described as a representative in order to give a limited description of the flow up to the start of communication with the operation unit 301.

The power supply control unit 322 transmits a power-on instruction to the main control unit power supply unit 321. The main control unit power supply unit 321 starts supplying power to the main CPU 324 through power-on control.

When the power supply is started, the operation unit 301 and the main CPU 324 start initialization, the main CPU 324 outputs a communication start request to the operation unit 301, and the operation unit 301 outputs a communication start response to the main CPU 324. When both the operation unit 301 and the main CPU 324 become ready to communicate, communication is started.

The initialization time of the operation unit 301 and the initialization time of the main CPU 324 are different from each other. Thus, in a case where the initialization of the operation unit 301 was slower than the initialization of the main CPU 324, the main CPU 324 needed to wait for the initialization of the operation unit 301, but by performing the initialization operation from the power supply in parallel, it is possible to start communication after a reduced waiting time.

In the present embodiment, the form has been described in which the main CPU 324 outputs the communication start request first and the operation unit 301 responds to the communication start request. However, communication may be started based on notification of a state with an H/L logic signal. A method may be employed in which the communication state is checked by issuing a command via a communication signal. In this case, the main CPU 324 needs to check the state by periodically sending a signal for checking the state. Due to the difference in initialization time, without a state notification being issued, it will be necessary to perform a retransmission flow, retry processing, setting of a timeout time, and the like so as not to cause an error at the time of starting communication, but details thereof will be omitted described.

The flow of FIG. 8B will now be described in detail. FIG. 8B illustrates a communication flow in the case of return from the power saving mode in response to an event other than an input to the operation unit 301. Examples of the return from the power saving mode in response to an event other than an input to the operation unit 301 include paper detection at the scanner unit 340 and the printer unit 350, and print processing via a network.

When the image forming apparatus 100 detects return from the power saving mode, the power supply control unit 322 issues a power supply instruction. At this time, the power supply control unit 322 may supply power to all units of the image forming apparatus 100, or may supply power only to necessary units. As for the supply of power only to necessary units, specifically, in the case of print processing via a network, power is supplied only to the main control unit 320 and the printer unit 350 without supplying power to the operation unit 301 or the scanner unit 340.

In FIG. 8B, as an example of the embodiment, a unit that always supplies power on returning from the power saving mode is indicated by a solid line as the main control unit 320, and a unit that does not supply power in some cases is indicated by a dotted line as the operation unit 301. In FIG. 8B, despite the indication by the solid line and the dotted line, the communication flow will be described assuming that the operation unit 301 is also returned.

The power supply control unit 322 transmits a power-on instruction to the operation unit power supply unit 303 and the main control unit power supply unit 321. On receiving the power-on instruction, the operation unit power supply unit 303 supplies power to the entire operation unit 301 through power-on control. On receiving the power-on instruction, the main control unit power supply unit 321 starts supplying power to the main CPU 324 through power-on control.

When the power supply is started, the operation unit 301 and the main CPU 324 start initialization, the main CPU 324 outputs a communication start request to the operation unit 301, and the operation unit 301 outputs a communication start response to the main CPU 324. When both the operation unit 301 and the main CPU 324 become ready to communicate, communication is started.

As described above, a unit, such as the operation unit 301, having the function of receiving user inputs transmits a return signal in response to a user input to the power supply control unit 322 as a unit of the main control unit 320, and also generates a return signal in the unit and transmits the return signal, allowing early return from the power saving mode in return control of the unit.

### Second Embodiment

While in the first embodiment, the return control from the power saving mode has been described by taking the operation unit 301 as an example, in a second embodiment, return control from the scanner unit 340 will be described as an example. Further, examples of user inputs assumed to occur in the scanner unit 340 and the printer unit 350 include paper detection and opening/closing detection, which correspond to similar processing, and thus, the scanner unit 340 will be described as a representative.

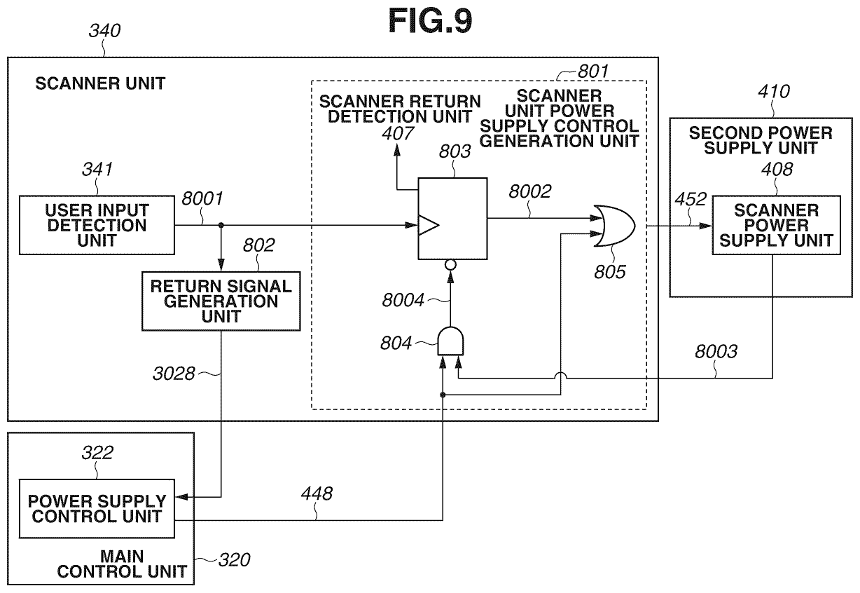

FIG. 9 is a block diagram illustrating details of power supply control signals of the scanner unit 340. The scanner unit 340 includes the user input detection unit 341, a scanner unit power supply control generation unit 801, and a return signal generation unit 802. The scanner unit power supply control generation unit 801 includes a latch circuit 803, a logic 804, and a logic 805.

The main control unit 320 includes the power supply control unit 322. The second power supply unit 410 includes the scanner power supply unit 408. The printer power supply unit 406 and the scanner power supply unit 408 are supplied with power via a power supply line 422.

The scanner unit 340 performs return control from the power saving mode using a user input detection signal 8001 output when the user input detection unit 341 determines that an input from a user has been performed. Examples of user inputs at the scanner unit 340 include detection of document paper and detection of opening/closing for platen scanning. The user input detection signal 8001 is output to the return signal generation unit 802 and the scanner unit power supply control generation unit 801.

The return signal generation unit 802 is connected to the power supply control unit 322 via a return signal 3028 that is output to the main control unit 320 and via which the entire image forming apparatus 100 is returned from the power saving mode.

On receiving the return signal 3028, the power supply control unit 322 starts a return operation from the power saving mode. The return signal generation unit 802 performs control to output the return signal 3028 only in the power saving mode so as not to cause erroneous detection in the standby mode, and control to output the return signal 3028 with a certain width or more so as to reliably receive the user input detection signal 8001, but details thereof will be omitted in the present embodiment.

The scanner unit power supply control generation unit 801 controls the power supply of the scanner unit 340.

The user input detection signal 8001 is connected to the latch circuit 803. The latch circuit 803 performs control using, for example, a flip-flop circuit. The latch circuit 803 as one example includes a clear pin, and is configured to issue an off command when the scanner power supply unit 408 is an ON state and the power supply control unit 322 is in the standby mode.

Specifically, the scanner unit power supply control generation unit 801 includes the logic 804 configured to clear the latch circuit 803 in a case where both a power state notification signal 8003 indicating that the scanner power supply unit 408 is turned ON and the power mode notification signal 448 indicate the standby mode. The latch circuit 803 connects a clear signal 8004 to the clear pin, and sets a latch return signal 8002 to L in a clear state.

The latch circuit 803 also controls the latch return signal 8002 such that the latch circuit 803 returns from the power saving mode when the logic is changed via a user input detection by the user input detection signal 8001. Specifically, the latch circuit 803 uses, as an input signal, the power supply of the scanner return detection unit 407, which is supplied with power even in the power saving mode and sets the input to H at all times, so that the latch return signal 8002 is set to H in response to the user input detection signal 8001.

The power supply control unit 322 outputs the power mode notification signal 448 for controlling the power supply of the scanner unit 340, and the scanner power supply unit 408 is subjected to power supply control in accordance with the power mode notification signal 448. The return signal 452 for controlling the output of the scanner power supply unit 408 is output by the logic 805 that outputs H indicating ON in a case where either the latch return signal 8002 or the power mode notification signal 448 is a signal that causes the scanner power supply unit 408 to be turned ON.

In this manner, a unit having the function of receiving user inputs transmits the return signal 3028 in response to a user input to the power supply control unit 322 as a unit of the main control unit 320, and also generates the return signal 452 in the unit and transmits the return signal 452, allowing early return from the power saving mode in return control of the unit.

It is desirable for the scanner unit power supply control generation unit 801 to be used in return control from the power saving mode, and for the transition operation to be performed only from the power supply control unit 322. The reason is that use of the scanner unit power supply control generation unit 801 at the time of transition from the power saving mode could prevent a communication partner, specifically the scanner unit 340, from communicating without an instruction from the main control unit 320, causing the main control unit 320 to detect that state as an anomaly to determine the state to be an error. Thus, the signal from the scanner unit power supply control generation unit 801 may be only used in return from the power saving mode.

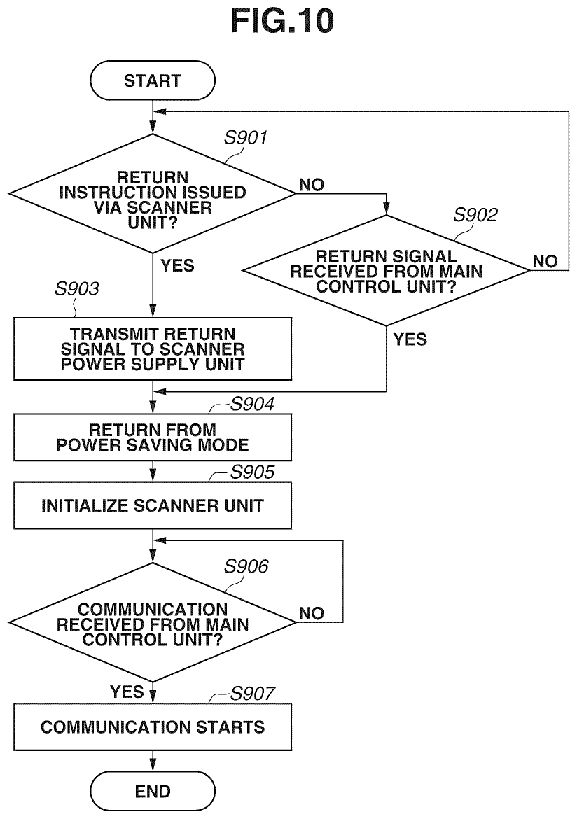

FIG. 10 is a flowchart illustrating return control from the power saving mode according to the second embodiment. The scanner unit 340 is a scanner unit. The main control unit 320 is a main control unit. The scanner unit 340 in the power saving mode (power-off control) starts the process of the flowchart of FIG. 10. Hereinafter, a method of controlling the scanner unit 340 will be described.

In step S901, the scanner unit power supply control generation unit 801 receives the user input detection signal 8001 from the user input detection unit 341 with the scanner unit 340 being in the power saving mode. Then, the scanner unit power supply control generation unit 801 determines whether the user input detection signal 8001 indicates that a user input has been performed. Examples of the user input at the scanner unit 340 include detection of a document sheet and detection of opening/closing for platen scanning a pressing plate. If the scanner unit power supply control generation unit 801 determines that the user input detection signal 8001 indicates that a user input has been performed (YES in step S901), the scanner unit power supply control generation unit 801 determines that the indication is regarded as an issuance of a return instruction, and the processing proceeds to step S903. If the user input detection signal 8001 does not indicate that a user input has been performed (NO in step S901), the scanner unit power supply control generation unit 801 determines that the user input detection signal 8001 indicates no issuance of a return instruction, and the processing proceeds to step S902.

The user input is an example of a return factor. It is sufficient that the user input detection unit 341 functions as a detection unit that detects a return factor at the scanner unit 340 and then outputs the user input detection signal 8001. The return factor is, for example, document detection or opening/closing detection of the scanner unit 340. If a return factor in the scanner unit 340 is detected (YES in step S901), the scanner unit power supply control generation unit 801 determines that the detection is regarded as an issuance of a return instruction, and the processing proceeds to step S903. If no return factor is detected in the scanner unit 340 (NO in step S901), the scanner unit power supply control generation unit 801 determines that no detection is regarded as no issuance of a return instruction, and the processing proceeds to step S902.

In step S902, the scanner unit power supply control generation unit 801 receives the power mode notification signal 448 from the main control unit 320 with the scanner unit 340 being in the power saving mode.

Then, the scanner unit power supply control generation unit 801 determines whether the power mode notification signal 448 indicates return from the power saving mode to another mode (the standby mode or the job execution mode). The power mode notification signal 448 is an example of a return signal. If the scanner unit power supply control generation unit 801 determines that the power mode notification signal 448 does not indicate return from the power saving mode (NO in step S902), the processing returns to step S901, and the power saving mode is maintained until return. If the scanner unit power supply control generation unit 801 determines that the power mode notification signal 448 indicates return from the power saving mode (YES in step S902), the scanner unit power supply control generation unit 801 transmits the return signal 452 to the scanner power supply unit 408, and the processing proceeds to step S904.

In step S903, the scanner unit power supply control generation unit 801 transmits the return signal 452 to the scanner power supply unit 408, and the processing proceeds to step S904. In this manner, the two determinations made in steps S901 and S902 allows return from the power saving mode based on a return instruction from either the scanner unit 340 or the main control unit 320. The return signal generation unit 802 transmits the return signal 3028 to the power supply control unit 322 of the main control unit 320. The return signal 3028 indicates return.

In step S904, the scanner unit 340 performs an operation for returning from the power saving mode to another mode (the standby mode or the job execution mode). Specifically, the scanner unit 340 functions as a control unit that performs power-on control on the scanner unit 340 as the return operation. In the power saving mode before the return, the scanner unit 340 performs power-off control on the scanner unit 340. In step S904, after the image forming apparatus returns from the power saving mode, the processing proceeds to step S905.

In step S905, the scanner unit 340 initializes the scanner unit 340.

In step S906, the scanner unit 340 determines whether the scanner unit 340 has received communication including communication start from the main control unit 320. Specifically, the scanner unit 340 checks the state of a state signal indicating that the main control unit 320 is ready to communicate and the state of a state signal indicating that the scanner unit 340 is ready to communicate, and determines whether the scanner unit 340 has received initial communication. If a communication state can be established only via the initial communication, a state signal indicating a communicable state may be omitted. If the scanner unit 340 determines that the scanner unit 340 has received no communication (NO in step S906), the processing returns to step S906. If the scanner unit 340 determines that the scanner unit 340 has received communication (YES in step S906), the processing proceeds to step S907.

In step S907, the scanner unit 340 starts communication with the main control unit 320.

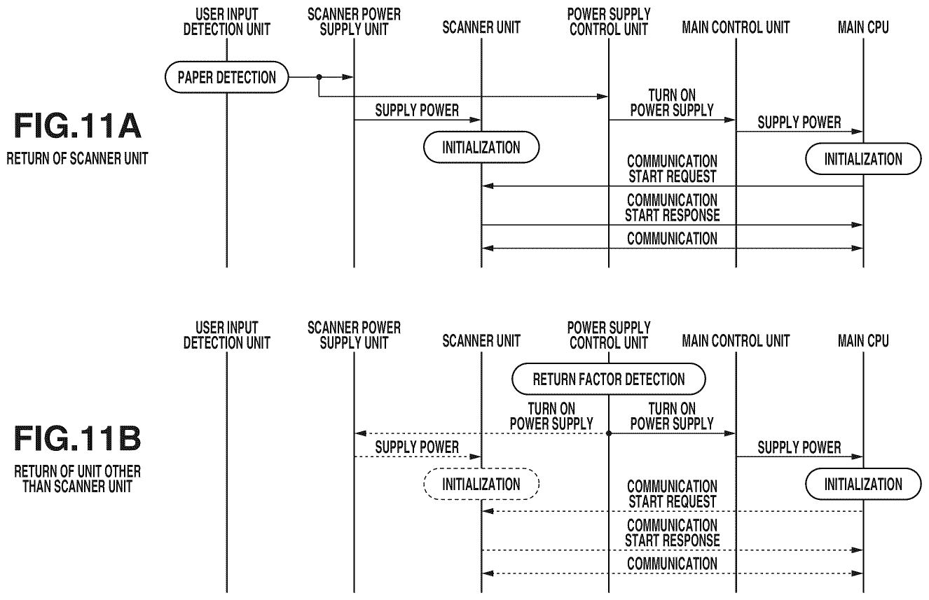

FIGS. 11A and 11B are each a diagram illustrating a communication flow of each block in a return process from the power saving mode. FIG. 11A illustrates return control from the scanner unit 340, and FIG. 11B illustrates return control from the main control unit 320, which is return control from a unit other than the scanner unit 340.

The flow of FIG. 11A will be described in detail first. When the user input detection unit 341 detects a user input, the user input detection unit 341 transmits a power-on instruction to the scanner power supply unit 408 and the power supply control unit 322. On receiving the power-on instruction, the scanner power supply unit 408 supplies power to the entire scanner unit 340 through power-on control. At this time, the scanner power supply unit 408 may be controlled to turn on/off the power in the scanner unit 340, or a power supply and a power supply control circuit may be disposed outside the scanner unit 340, but the details thereof will be omitted.

On receiving the power-on instruction, the power supply control unit 322 instructs the entire image forming apparatus 100 to return from the power saving mode. In FIGS. 11A and 11B, only the main control unit 320 is described as a representative in order to give a limited description of the flow up to the start of communication with the scanner unit 340. The power supply control unit 322 transmits a power-on instruction to the main control unit power supply unit 321. The main control unit power supply unit 321 starts supplying power to the main CPU 324 through power-on control.

When the power supply is started, the scanner unit 340 and the main CPU 324 start initialization, the main CPU 324 outputs a communication start request to the scanner unit 340, and the scanner unit 340 outputs a communication start response to the main CPU 324. When both the scanner unit 340 and the main CPU 324 become able to communicate, communication is started.

The initialization time of the scanner unit 340 and the initialization time of the main CPU 324 are different from each other. Thus, in a case where the initialization of the scanner unit 340 was slower than the initialization of the main CPU 324, the main CPU 324 needed to wait for the initialization of the scanner unit 340, but by performing the initialization operation from the power supply in parallel, it is possible to start communication after a reduced waiting time.

In the present embodiment, the form has been described in which the main CPU 324 outputs a communication start request first, and the scanner unit 340 responds to the communication start request. However, communication may be started based on notification of a state with an H/L logic signal. A method may be employed in which the communication state is checked by issuing a command via a communication signal. In this case, the main CPU 324 needs to check the state by periodically sending a signal for checking the state. Due to the difference in initialization time, without a state notification being issued, it will be necessary to perform a retransmission flow, retry processing, setting of a timeout time, and the like so as not to cause an error at the time of starting communication, but details thereof will be omitted described.

The flow of FIG. 11B will now be described in detail. FIG. 11B is a communication flow in the case of return from the power saving mode in response to an event other than a user input to the scanner unit 340. Examples of the return from the power saving mode in response to an event other than a user input to the scanner unit 340 include a touch on the touch panel 305 of the operation unit 301, paper detection at the printer unit 350, and print processing via a network.

When the image forming apparatus 100 detects the return from the power saving mode, the power supply control unit 322 issues a power supply instruction. At this time, the power supply control unit 322 may supply power to all units of the image forming apparatus 100, or may supply power only to necessary units. As for the supply of power only to necessary units, specifically, in the case of a touch on the touch panel 305 of the operation unit 301, power is supplied only to the main control unit 320 and the operation unit 301 without supplying power to the scanner unit 340 or the printer unit 350 immediately after the input is received.

In FIG. 11B, as an example of the embodiment, a unit that always supplies power on returning from the power saving mode is indicated by a solid line as the main control unit 320, and a unit that does not supply power in some cases is indicated by a dotted line as the scanner unit 340. In FIG. 11B, despite the indication by the solid line and the dotted line, the communication flow will be described assuming that the scanner unit 340 is also returned.

The power supply control unit 322 transmits a power-on instruction to the scanner power supply unit 408 and the main control unit power supply unit 321. On receiving the power-on instruction, the scanner power supply unit 408 supplies power to the entire scanner unit 340 through power-on control. On receiving the power-on instruction, the main control unit power supply unit 321 starts supplying power to the main CPU 324 through power-on control.

When the power supply is started, the scanner unit 340 and the main CPU 324 starts initialization, the main CPU 324 outputs a communication start request to the scanner unit 340, and the scanner unit 340 outputs a communication start response to the main CPU 324. When both the scanner unit 340 and the main CPU 324 become able to communicate, communication is started.

As described above, as in the first embodiment, a unit, such as the scanner unit 340, having the function of receiving user inputs transmits the return signal 3028 in response to a user input to the power supply control unit 322 as a unit of the main control unit 320, and also generates the return signal 452 in the unit and transmits the return signal 452, allowing early return from the power saving mode in return control of the unit.

While the case of the scanner unit 340 has been described above as an example, the case of the printer unit 350 is similar to that of the scanner unit 340. The printer unit 350 is a printer unit. The user input detection unit 351 of the printer unit 350 detects a return factor in the printer unit 350. The return factor is, for example, document detection or opening/closing detection at the printer unit 350.

As described above, the first and second embodiments are applicable to a unit, such as the operation unit 301, the scanner unit 340, or the printer unit 350. Making earlier power supply to each unit after reception of a user input makes it possible to shorten the return control time. This allows the time to supply power to each unit that has caused return to be shortened.

### Other Embodiments

The present disclosure can also be implemented by a process in which a program that carries out one or more functions of the above-described embodiments is supplied to a system or an apparatus via a network or a storage medium, and one or more processors in a computer of the system or the apparatus read and execute the program. The present disclosure can also be implemented with a circuit (e.g., an application specific integrated circuit (ASIC)) that implements one or more functions.

In addition, any of the above-described embodiments is merely a specific example for implementing the present disclosure, and the technical scope of the present disclosure is not construed in a limited manner by these embodiments. That is, the present disclosure can be implemented in various forms without departing from the technical idea or the main features thereof.

According to the present disclosure, in a case where a return factor is detected, power-on control can be performed early.

Embodiment(s) of the present disclosure can also be implemented by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-160830, filed Sep. 18, 2024, which is hereby incorporated by reference herein in its entirety.

What is claimed is:

1. An image forming apparatus comprising:
a detection unit configured to detect a return factor in the image forming apparatus; and
a control unit configured to perform power-on control on the image forming apparatus in any case where the detection unit detects the return factor or where a signal indicating return is received from another image forming apparatus.

2. The image forming apparatus according to claim 1, wherein, in a case where the detection unit detects the return factor, the control unit transmits the signal indicating return to the other image forming apparatus.

3. The image forming apparatus according to claim 1, wherein the control unit performs an initialization operation on the unit after the power-on control.

4. The image forming apparatus according to claim 1, wherein the control unit performs communication with the other image forming apparatus after the power-on control.

5. The image forming apparatus according to claim 1, wherein the control unit performs a process of returning from a power saving mode to another mode in any case where the detection unit detects the return factor or where the signal indicating return is received from the other image forming apparatus.

6. The image forming apparatus according to claim 1, wherein in a state of power-off control on the unit, the control unit performs the power-on control on the image forming apparatus in any case where the detection unit detects the return factor or where the signal indicating return is received from the other image forming apparatus.

7. The image forming apparatus according to claim 1, wherein the image forming apparatus is an operation unit.

8. The image forming apparatus according to claim 7, wherein the return factor is an operation of a user on the operation unit.

9. The image forming apparatus according to claim 1, wherein the image forming apparatus is a scanner unit.

10. The image forming apparatus according to claim 9, wherein the return factor is detection of a document or detection of opening and closing at the scanner unit.

11. The image forming apparatus according to claim 1, wherein the image forming apparatus is a printer unit.

12. The image forming apparatus according to claim 11, wherein the return factor is detection of a document or detection of opening and closing at the printer unit.

13. An image forming apparatus system comprising:
a first unit as the image forming apparatus including:
a detection unit configured to detect a return factor in the image forming apparatus; and
a control unit configured to perform power-on control on the image forming apparatus in any case where the detection unit detects the return factor or where a signal indicating return is received from another image forming apparatus,
wherein, in a case where the detection unit detects the return factor, the control unit transmits the signal indicating return to the other image forming apparatus; and
a second unit different from the first unit,
wherein, in a case where the second unit receives the signal indicating return from the first unit, the second unit performs power-on control on the second unit.

14. A control method for an image forming apparatus, the method comprising:
detecting a return factor in the image forming apparatus; and
performing power-on control on the image forming apparatus in any case where the return factor is detected in the detection or where a signal indicating return is received from another image forming apparatus.

15. A non-transitory computer-readable storage medium storing a program for causing an image forming apparatus to execute a control method, the program causing a computer to:
detect a return factor in the image forming apparatus; and
perform power-on control on the image forming apparatus in any case where the return factor is detected or where a signal indicating return is received from another image forming apparatus.
